(19) United States
(12) Patent Application Publication
(10) Pub. No.: US 2009/0249966 A1
(43) Pub. Date: Oct. 8, 2009

(54) DEVICE FOR IMPROVING THE CONSISTENCY OF AN INTERNAL BOND STRENGTH TEST ON GLUED BIO-BASED PANEL PRODUCTS

(76) Inventor: Stephen Young, New Plymouth (NZ)

Correspondence Address: OSRAM SYLVANIA INC, 100 ENDICOTT STREET, DANVERS, MA, 01923, US

(21) Appl. No.: 12/302,512

(22) PCT Filed: May 28, 2007
(86) PCT No.: PCT/NZ07/00128

§ 371 Date: Jun. 9, 2009

(30) Foreign Application Priority Data
May 26, 2006 (NZ) 547538

(51) Int. Cl. B30B 15/34; B30B 1/08; B30B 1/16

(52) U.S. Cl. 100/38; 100/315; 100/326; 100/270

(57) ABSTRACT

The present invention provides for a device for preparing a glued bio-based panel product test-piece suitable for undertaking an internal bond strength test, the device comprising a base 2, and a press plate 3 and an actuator 4 capable of moving the press plate 3 towards the base 2 with a specific pressure, allowing the bonding of at least one plate to the bio-based panel sample.

### FIELD OF INVENTION

The invention relates to a device for preparing a glued bio-based panel product test-piece suitable for undertaking an internal bond strength test.

### BACKGROUND

The bio-based panels manufacturing industry uses the technologies of gluing and pressing together of particles of a bio derived fibre to produce durable panel products fit for use in a wide range of applications. During the manufacturing process, bio-based furnish, such as raw fibre, wood particle or wood flake, is mixed with a quantity of a glue that is then formed into a loose mat ready for pressing into a board. The pressing process involves the application of high temperature and pressure via a heated metal platen to create the conditions required for polymerisation of the particular glue. The polymerised glue creates integrity between the particle of the furnish, which provides a panel with good mechanical strength properties suitable for the required end uses.

The internal bonding within the panel is critical to the strength properties of the panel, and therefore it is important to be able to accurately and constantly measure the internal bond strength to ensure a product of consistent quality is being produced. For this reason, the internal bond strength test, commonly called an IB-test, is an important tool in quality monitoring in the manufacturing process. Board manufacturing plants routinely carry out this test in on-site laboratories dedicated to the quality assurance of the product.

The standard procedure for carrying out IB-tests consists of gluing metal plates to the two faces of a sample of a board. The two plates are then pulled apart, whilst measuring the force applied, until the internal structure of the board gives way. The result is an indication of the quality of the internal bond strength. It is an important part of the test that the bond between the metal plate and the board surface does not interfere with the action of the test, as failure must occur within the panel and not at the metal/panel interface. Imperfect bonding can result in variability in the test.

Internationally observed standards (such as AS/NZS 4266:06) for the test have been set down and must be carried out precisely to follow the standard each time the test is undertaken. However, these procedures can be time consuming and are prone to operator error, and are therefore still subject to variability between readings, both within a particular laboratory and between laboratories. The time taken to fully comply with the standard procedures can also make these methods unsuitable for use in commercial production.

The object of the present invention is to provide a device to decrease the variability of bonding metal plates to a sample board to improve the standardisation of the internal bond test, or to at least provide a useful alternative.

### SUMMARY OF THE INVENTION

According to a first aspect the present invention provides for a device for bonding a sample of a bio-based panel to one or more plates comprising:
a base;
a press plate; and
an actuator capable of moving the press plate towards the base with a specific pressure.

The base and/or the press plate can include a heat cooling unit. The cooling unit may comprise a fluid assisted temperature control.

The base and/or the press plate may include a heating unit to pre-heat the base and/or the press plate.

The heating unit can be integrated into the base and/or press plate, for example an electrical heating element. Alternatively, the heating unit can be external and provide heat to the base and/or press plate via a heat exchanger, for example via a heated fluid.

The heating unit can also include a thermostat to ensure that the base and/or press plate is heated to, or maintained at a predetermined temperature.

The actuator may comprise an electric actuator, or it may comprise an air or hydraulic ram.

In a second aspect the invention provides for a method of forming a bond between a sample of a bio-based panel to one or more plates suitable for use in an internal bond strength test, comprising the steps of:
providing a sample of a bio-based panel;
pre-heating at least one plate;
applying an adhesive between at least one side of the sample and a plate;
Applying pressure to the sample and the at least one plate using a device according to the first aspect of the invention for a sufficient time to cause bonding of the heat sensitive adhesive to the sample and the plate.

The method can include the additional step of pre-heating the base plate and/or press plate to a predetermined temperature. The predetermined temperature can also be maintained for a set time during the step of applying pressure to the sample.

The method can also include the step cooling the base and/or press plate during the step of applying pressure to the sample.

### DETAILED DESCRIPTION

The invention will now be explained by way of example with reference to the following figures:

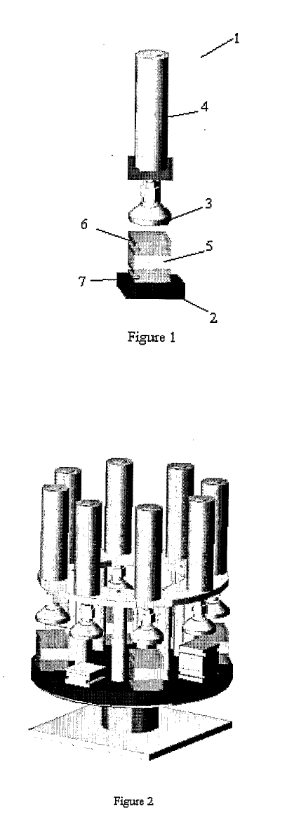

FIG. 1: Shows a side view of a device according to the present invention.

FIG. 2: Shows a perspective view of an arrangement of devices according to the present invention.

As illustrated in the FIG. 1, the device 1 comprises a base 2. The base 2 can include a temperature control (not shown) to help draw temperature away from the base. The temperature control may be an element or fluid assisted. The base can also include a heating unit, normally integrated with a thermostat, to heat the base to, and/or maintain the base, at a predetermined temperature.

The heating unit can be internal to the base 2, for example a element. Alternatively, the heat source may be external and provided to the base 2 via a heat exchange, for example via a fluid. In such a case the heating unit and the temperature control may be integrated, where heated fluid is provided to heat the base 2 and cool fluid is provided to draw heat from the base 2.

Above the base 2 is a press plate 3, connected to an actuator 4. The actuator is able to move the upper press plate 3 towards the base 2 with a set force. It will be appreciated that the actuator may also be connected to the base 2 and move the base 2 towards the press plate 3. Therefore, the system of applying pressure may occur from above or below.

The press plate 3 can also include a temperature control unit and/or a heating unit as described for the base 2.

In use a sample of a bio-based panel product 5 is placed between a lower plate 6 and a upper plate 7, with a layer of a heat and/or pressure sensitive adhesive, or hot melt glue, between each interface. The lower 6 and upper 7 plates may be pre-heated to a desired temperature. Alternatively, the base 2 and press plate 3 can be pre-heated to the desired temperature, which in turn heat the plates 6 and 7 in use. If not already in position this is then placed between the base 2 and the press plate 3. The actuator 4 then lowers the press plate 3 to come into contact with the upper plate 7. The actuator 4 then applies a predetermined force to the upper plate 7, sample product 5 and lower plate 6, for a set time. The heated plates 6 and 7 cause the heat sensitive adhesive to melt. The pressure applied by the device ensures an even spread, and continual contact of the heat sensitive adhesive to the sample and plate, while the heat sensitive adhesive cools and bonds with the sample and plate. The fluid assisted temperature unit in the base 2 and/or press plate 3 helps conduct heat away from the plates ensuring an even cooling of the heat sensitive adhesive.

It will be appreciated that the predetermined temperature, of pre-heating the base 2, press plate 3 and/or the lower 6 and upper 7 plates will depend on the particular heat sensitive adhesive being used. Heating of the base 2 and/or press plate 3 may continue for a set time during the application of pressure by the actuator 4 to ensure compete melting and distribution of the adhesive, prior to allowing the system to cool. Similarly, the pressure applied by the actuator 4 and timers will depend on a particular application, including adhesive used, composite board to be tested and heating method.

Any suitable actuator may be used provided that is able to apply a set force to the press plate 3. The actuator may comprise an air or hydraulic ram, an electrical actuator or the like.

Optionally, the device may be controlled by a central control unit to automate the pressure applied by the actuator 4, the duration of the application of the pressure, or the temperature of the base 2 and/or press plate 3.

Heat sensitive adhesives, or hot melt glues, are known in the art, and any suitable one can be used in the present invention. It will be appreciated that other adhesives may also be used. For example, pressure sensitive adhesives may also be used, in which case heating of the plates 6 and 7, base 2 and/or press plate 3 will not necessarily be required. It will also be appreciated that the main requirement of the adhesive is that it provides a bond between the plate and the bio-based panel that is greater than the internal bonding of the bio-based panel, such that failure occurs within the panel during internal-bond test. Such adhesives are well known in the art.

As shown in FIG. 2, a plurality of devices can be grouped together to allow more than one sample board to be bonded to upper and lower plates 6 and 7. The pluralities of devices may be arranged in a circular pattern to allow easy access to each device or may be arranged in other patterns.

The device 1 has shown a reduction in variability of results when used to prepare a sample of bio-based panel for the internal bond strength test. Internal bond strength test results from tests performed using samples prepared using the device according to the present invention are remarkably consistent. There is a reduction in the differences observed between laboratories, within operators in a single laboratory and between the same operator at one laboratory.

The design principle for the device complies with the international standards and also controls the temperature of the glue and sample during gluing, the pressure applied to sample during gluing of the sample, the time pressure is applied to the sample, the rate of cooling and the temperature at time of testing. While some of these parameters can be controlled without the use of the present device, the present device enables exact replication of the conditions and it is this control which reduces the variability of the test results. The present device has also proven to be faster than the manual system, both in terms of the time input by the operators and in terms of the time from start to end of the process.

To obtain consistent results the important factors are controlling of the conditions of pressure temperature and time. The combination of a controlled pressure using a hydraulic ram or similar pressure controlled device, and the simultaneous holding of the correct temperature for a fixed time, or until a given internal temperature with the test piece, has been found to greatly increase the stability and reproducibility of the test. When carrying out the test normally, it is not possible to maintain this stable state for the bonding process to occur satisfactorily.

Wherein in the foregoing description, reference has been made to features having known equivalents, those equivalents are hereby incorporated as if they have been specifically set fourth.

Although the invention has been described by way of example, it should be appreciated that variations and modifications may be made without departing from the scope of the invention.

What we claim is:

1. A device for bonding a sample of a bio-based panel to one or more plates comprising:
a base;
a press plate; and
an actuator capable of moving the press plate towards the base with a specific pressure.

2. A device according to claim 1, wherein the base and/or the press plate include a cooling unit.

3. A device according to claim 2, wherein the cooling unit comprises a fluid assisted temperature control.

4. A device according to claim 1, wherein the base and/or the press plate comprises a heating unit.

5. A device according to claim 4, wherein the heating unit is an electrical heating element.

6. A device according to claim 4, wherein the heating unit comprises a external fluid heating unit and a heat exchanger.

7. A device according to claim 4, wherein the heating unit includes a thermostat.

8. A device according to claim 1, wherein the actuator is an electric actuator.

9. A device according to claim 1, wherein the actuator is an air or hydraulic ram.

10. A method of forming a bond between a sample of a bio-based panel to one or more plates suitable for use in an internal bond strength test, comprising the steps of:
providing a sample of a bio-based panel;
applying an adhesive between at least one side of the sample and a plate;
applying pressure to the sample and at least one plate using a device according to claim 1 for a sufficient time to cause bonding of the adhesive to the sample and at least one plate.

11. A method according to claim 10, wherein the step of applying pressure includes applying heat to the sample and at least one plate.

12. A method according to claim 11, comprising the extra step of pre-heating the plate to provide the heat during the step of applying the pressure.

13. The method according to claim 11, including the step of pre-heating the base plate and/or press plate to a predetermined temperature.

14. A method according to claim 13, wherein the temperature in the base and/or press plate is maintained for a set time during the step of applying pressure to the sample.

15. A method according to claim 11, wherein the base and/or press plate are cooled during the step of applying pressure to the sample.

16. A method according to claim 10, wherein the adhesive is a heat sensitive adhesive.

17. A method according to claim 10, wherein the adhesive is a pressure sensitive adhesive.
